(19) United States
(12) Patent Application Publication
(10) Pub. No.: US 2009/0028559 A1
(43) Pub. Date: Jan. 29, 2009

(54) Method and System for Designing a Network

(75) Inventors: Jian Li, Sunnyvale, CA (US); Canhui Ou, Danville, CA (US); Kaiyan Chen, Pleasanton, CA (US)

Correspondence Address: AT&T Legal Department, Attn: Patent Docketing, Attn: Patent Docketing Room 2A- 207, One AT & T Way, Bedminster, NJ, 07921, US

(73) Assignee: AT&T KNOWLEDGE VENTURES, LP, Reno, NV (US)

(21) Appl. No.: 11/828,674

(22) Filed: Jul. 26, 2007

(51) Int. Cl. H04J 14/00

(52) U.S. Cl. 398/45

(57) ABSTRACT

A design of a network is determined to connect a plurality of central offices (COs) to a video hub office (VHO) using a plurality of fiber path pairs, respectively. In the design, each of the fiber path pairs is a lowest-cost, node-disjoint path pair between its respective one of the COs and the VHO independent of a cost of adding new fiber to the network. The design is modified to reduce the cost of adding new fiber to the network by re-routing traffic from at least one of the fiber path pairs to at least one other fiber path pair.

### FIELD OF THE DISCLOSURE

The present disclosure is generally related to methods and systems for designing a network.

### BACKGROUND

A computer-implemented network design tool may be used to design some network architectures. Some network architectures comprise a video hub office that cooperates with a set of central offices to provide video services and other services to users.

### BRIEF DESCRIPTION OF THE DRAWINGS

FIG. 1 is a flow chart of an embodiment of a computer-implemented method of designing a network to connect a set of central offices (COs) to a video hub office (VHO);

FIG. 2 is a flow chart of an embodiment of a method of determining a plurality of designs of the network;

FIG. 3 is a flow chart of an embodiment of a method of determining one or more pairs of node-disjoint paths from the VHO to each CO;

FIG. 4 is a flow chart of an embodiment of a method of determining a base design for the network for a Yth traffic forecast;

FIG. 5 is a flow chart of an embodiment of a method of modifying the base design to optimize an overall design cost of the design; and

FIG. 6 is a block diagram of an illustrative embodiment of a general computer system.

### DETAILED DESCRIPTION OF THE DRAWINGS

Disclosed herein are embodiments of methods of generating a logical network routing design with a reduced overall cost in terms of equipment cost and transmission cost for a metro portion of a no-intermediate-office (no-IO) network architecture (e.g. one that connects central offices to a video hub office without an intermediate office). If fibers and/or wavelength division multiplexed (WDM) systems are the only transmission facilities, the method may provide a complete design for a metro portion of the no-IO network. Embodiments may provide a list of fiber spans where a new reconfigurable optical add-drop multiplexer (ROADM) ring could be placed to reduce transmission cost.

In some embodiments, the resulting design follows a stringent diversity requirement for connecting individual central offices directly to a video hub office, considers an additional cost for multiple aggregation tiers in a video hub office's future architecture, and jointly considers diversity requirements and capacity requirements to reduce an overall cost of a network design in terms of equipment cost and transmission cost. Embodiments of the method for generating the design can be performed in a matter of hours using a computer system.

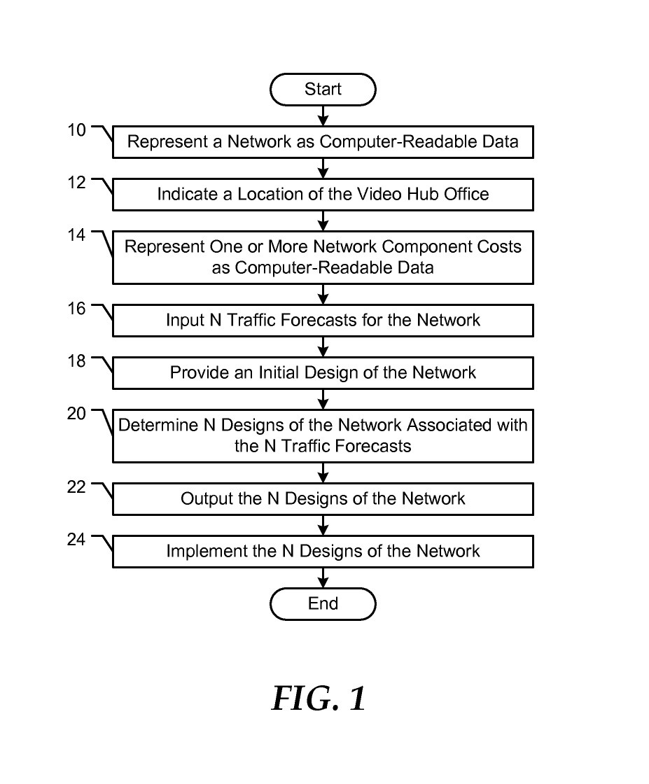

FIG. 1 is a flow chart of an embodiment of a computer-implemented method of designing a network to connect a set of central offices (COs) to a video hub office (VHO). The network may comprise a metro network that connects the COs to the VHO using fiber spans. The network may be used to provide an Internet Protocol television (IPTV) service, for example, to a plurality of subscribers.

As indicated by block 10, the method comprises representing elements and aspects of the network as computer-readable data stored by one or more computer-readable media. In an embodiment, the computer-readable data includes a bidirectional graph G to represent the metro network. The bidirectional graph comprises a set of nodes V and a set of edges E between pairs of the nodes V. The nodes V may comprise nodes to represent the set of central offices in the network, and the edges E may represent bidirectional fiber spans between pairs of the central offices. Each of the bidirectional fiber spans comprises one or more fibers to communicate signals between their endpoints. In alternative embodiments, the graph G may be a directed graph.

The computer-readable data may further comprise a set of values L to represent a respective length of each of the bidirectional fibers spans E, a set of values S to represent a respective number of spare fibers in each of the bidirectional fiber spans E, a set of values C_{S} to represent a respective cost of spare fibers per unit distance (e.g. per mile) for each of the bidirectional fiber spans E, and a set of values C_{N} to represent a respective cost of adding new fibers per unit distance (e.g. per mile) for each of the bidirectional fiber spans E.

As indicated by block 12, the method comprises indicating a location of the video hub office (VHO). In an embodiment, the location is indicated by indicating which of the nodes V represents the VHO.

As indicated by block 14, the method comprises representing one or more component costs as computer-readable data. The component costs may comprise costs of components that may be added to the network. The components may comprise components of a switch, such as an Ethernet service switch, and components of a router, such as a service router. An example of the Ethernet service switch is an Alcatel 7450 Ethernet Service Switch. An example of a service router is an Alcatel 7750 service router. Examples of the components costs include a cost of a chassis, and a cost of a line card.

As indicated by block 16, the method comprises inputting a plurality of N traffic forecasts for the network. The plurality of traffic forecasts comprises a sequence of traffic forecasts for a respective sequence of time periods. The traffic forecasts may be yearly, for example. The traffic forecasts may specify a forecast amount of unicast traffic and multicast traffic at each of the central offices for each of the time periods.

It is noted that some of the central offices may have not have an associated traffic forecast for a particular time period. For example, some of the central offices may have an associated traffic forecast at some subsequent time period. In these instances, the traffic forecast either may indicate that a central office has a traffic forecast of zero for the particular time period, or may not include the central office in a list of central offices with a forecast for a particular time period.

In an embodiment, the traffic forecasts comprise a multi-year traffic forecast which projects an amount of unicast traffic and multicast traffic at each of the central offices for each of a plurality of years. Each traffic forecast provides an associated list of central offices V_{Y} with a forecast for an associated year Y.

Optionally, as indicated by block 18, the method comprises providing an initial design of the network for a start time period. The initial design may be an existing design of the network, for example. The initial design may be represented by D.

As indicated by block 20, the method comprises processing the above values to determine a plurality of N designs of the network associated with the plurality of N traffic forecasts, respectively. The resulting designs can be represented by D_{Y}, where Y indexes the individual design periods and ranges from 1 to N.

The N designs are determined to minimize a total cost of a first design to satisfy a first traffic forecast for a first time period, and incremental costs of each subsequent design to satisfy each subsequent traffic forecast for each subsequent time period, subject to a first constraint of ensuring that each design includes two diverse fiber routes connecting each CO to the VHO, a second constraint of ensuring that each design is a subset of a design for a subsequent time period, and a third constraint of not placing any IOs in the network. The total cost comprises one or more equipment costs and one or more fiber costs.

The second constraint produces designs that incrementally augment the network without disrupting existing infrastructure. As a result, the design D_{Y} is a subset of the design D_{Y+1} for each value of Y from 1 to N−1. For yearly forecasts, for example, the second constraint ensures that the design for year Y is a subset of the design for year Y+1.

As indicated by block 22, the resulting designs D_{Y}, where Y ranges from 1 to N, are outputted by the computer. Examples of outputting the resulting designs include, but are not limited to, printing one or more hard copies of the resulting designs using a printer, displaying the resulting designs using a display device, communicating a signal that encodes the resulting designs via a signal-bearing medium, and storing the data that encodes the resulting designs using a computer-readable medium.

Embodiments can be used for both green-field and brown-field designs. A green-field design is a design in which an optimal or near-optimal design D₁ is generated from scratch for the first forecast period, and each design D₂ to D_{N} incrementally augments the design D₁ based on the forecast without disrupting services provided by the network. A brown-field design is a design in which the initial design D of the network is used, and each design D₁ to D_{N} incrementally augments the initial design D based on the forecast without disrupting existing services provided by the network.

As indicated by block 24, the method comprises deploying or otherwise implementing the resulting designs D_{Y} for their respective design periods Y=1 to N.

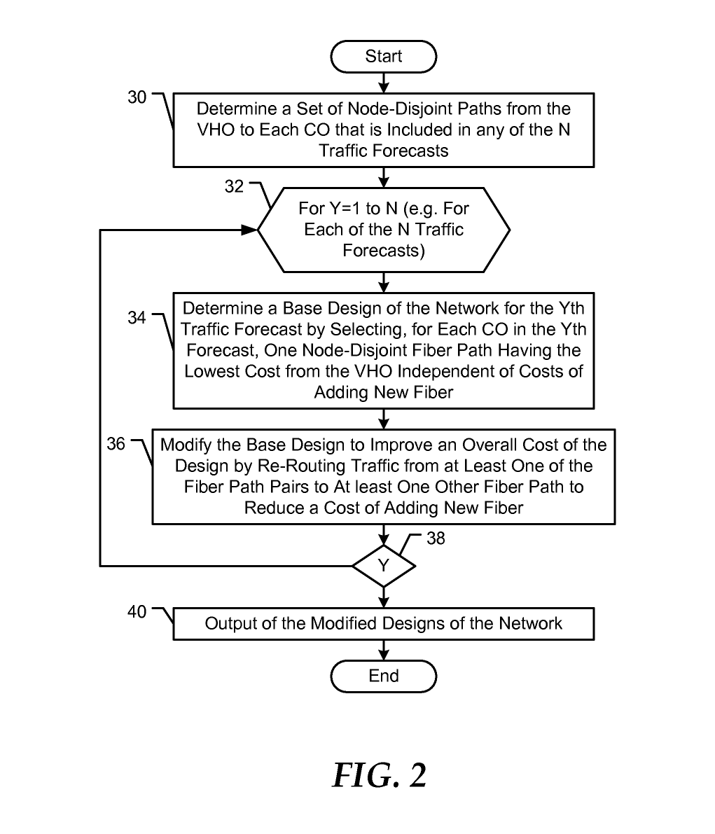

FIG. 2 is a flow chart of an embodiment of a method of determining the plurality of designs of the network.

As indicated by block 30, the method comprises determining a set of node-disjoint paths P from the VHO to each CO that is included in any of the traffic forecasts. This act may comprise determining pairs of node-disjoint paths from the VHO to each CO, for example, by applying Suurballe's algorithm to the first K shortest paths to get K′ pairs (where K′≦K) of node-disjoint paths from the VHO to each CO. The set of paths computed in this act are represented by P.

As indicated by block 32, the method performs acts for each of the N traffic forecasts. The traffic forecasts are indexed by a value Y, where Y ranges from 1 to N.

As indicated by block 34, the method comprises determining a base design for the network for the Yth traffic forecast. The base design is determined by selecting, for each CO in the Yth forecast, one node-disjoint pair from the VHO having a lowest cost. In general, the cost being minimized may comprise equipment cost(s) and/or transmission cost(s). However, in a preferred embodiment, the cost being minimized is independent of a cost of adding new fiber to the network. As a result, a plurality of pairs of the node-disjoint paths, each of the pairs of node-disjoint paths being from the VHO to a respective one of the COs, which optimizes a particular cost of the base design are determined. The resulting base design indicates particular fiber spans to connect the COs to the VHO.

As indicated by block 36, the method comprises modifying the base design to optimize an overall design cost of the design. In an embodiment, this act comprises selecting fiber spans that have more required fibers than spare fibers, and attempting to reroute some of the traffic on these fiber spans to other paths in order to reduce the cost of adding new fiber to the network (also known as trunk and toll costs). Thus, in the aforementioned embodiment, the base design is modified to reroute traffic from one or more of the fiber spans to one or more other paths, wherein the one or more fiber spans are those that have more required fibers than spare fibers. The base design may be modified to reduce a transmission cost by, for example, placing a reconfigurable optical add-drop multiplexer (ROADM) in the fiber span.

In a particular embodiment, the base design of a network connects the COs to the VHO using a plurality of fiber path pairs, respectively, wherein each of the fiber path pairs is a new-fiber-cost-independent, lowest-cost, node-disjoint path pair between its respective one of the COs and the VHO. Further in this particular embodiment, the base design is modified to reduce a cost of adding new fiber to the network by re-routing traffic from at least one of the fiber path pairs to at least one other fiber path pair.

As indicated by block 38, the index Y is incremented so that the above-described acts of determining a base design and modifying the base design are executed for each forecast time period in ascending order.

As indicated by block 40, the method comprises outputting the modified design for each forecast time period.

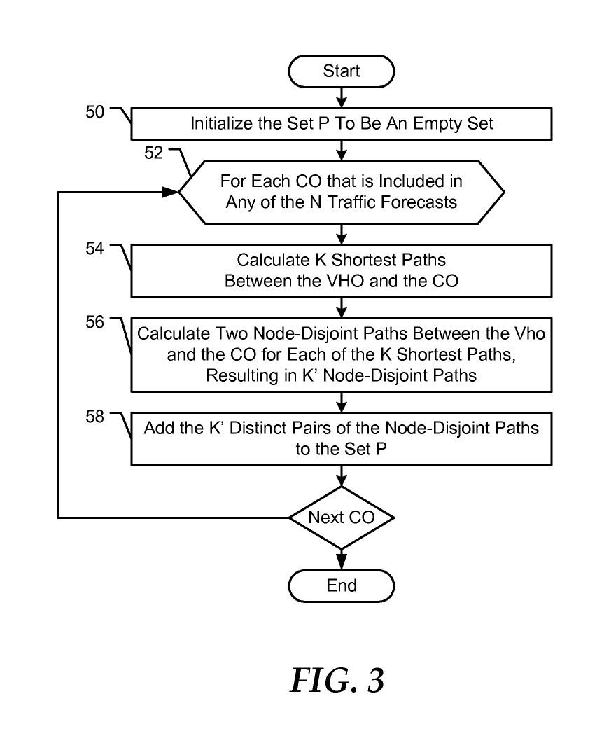

FIG. 3 is a flow chart of an embodiment of a method of determining up to K pairs of node-disjoint paths from the VHO to each CO. As indicated by block 50, the method comprises initializing the set P to be an empty set. As indicated by block 52, the method comprises executing acts for each CO that is included in any of the N traffic forecasts. The acts comprise a first act of calculating K shortest paths between the VHO and the CO (block 54). The K shortest paths may be determined using Yen's algorithm. The acts further comprise a second act of calculating two node-disjoint paths between the VHO and the CO for each of the K shortest paths (block 56). A set of K′ node-disjoint path pairs results, where K′≦K. The acts further comprise a third act of adding the K′ distinct pairs of node-disjoint paths to the set P (block 58). The set P is built by performing the aforementioned first, second, and third acts for each CO included in any of the traffic forecasts.

In an embodiment, the value of K is set to 10 by default. Optionally, a different value of K may be inputted by a user.

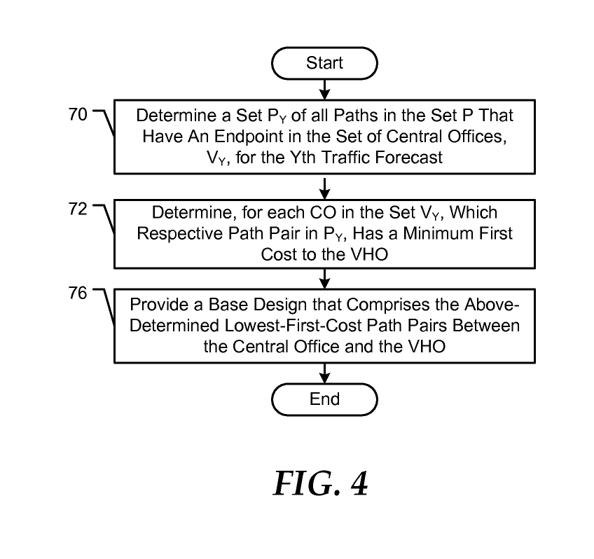

FIG. 4 is a flow chart of an embodiment of a method of determining a base design for the network for the Yth traffic forecast. As indicated by block 70, the method comprises determining a set P_{Y} of all paths in the set P that have an endpoint in the set of COs V_{Y} for the Yth traffic forecast. As indicated by block 72, the method comprises determining, for each CO in the set V_{Y}, which respective path pair in P_{Y} has a minimum first cost to the VHO. The first cost function being minimized may include an optic cost and/or a fiber cost, but may exclude any cost of adding new fiber to the network. Optionally, the path pairs in P_{Y} may be sorted in increasing order of the first cost to find the respective lowest-cost path pair for each of the COs. As indicated by block 74, the method comprises providing the base design that comprises the above-determined lowest-first-cost path pairs between the COs and the VHO. As indicated by block 76, the method comprises determining an overall cost of the base design. The overall design cost of the base design is based on a second cost function that differs from the first cost function. For example, the second cost function may include the cost of adding new fiber to the network (e.g. trunk and tolls costs) in addition to other optic and fiber costs.

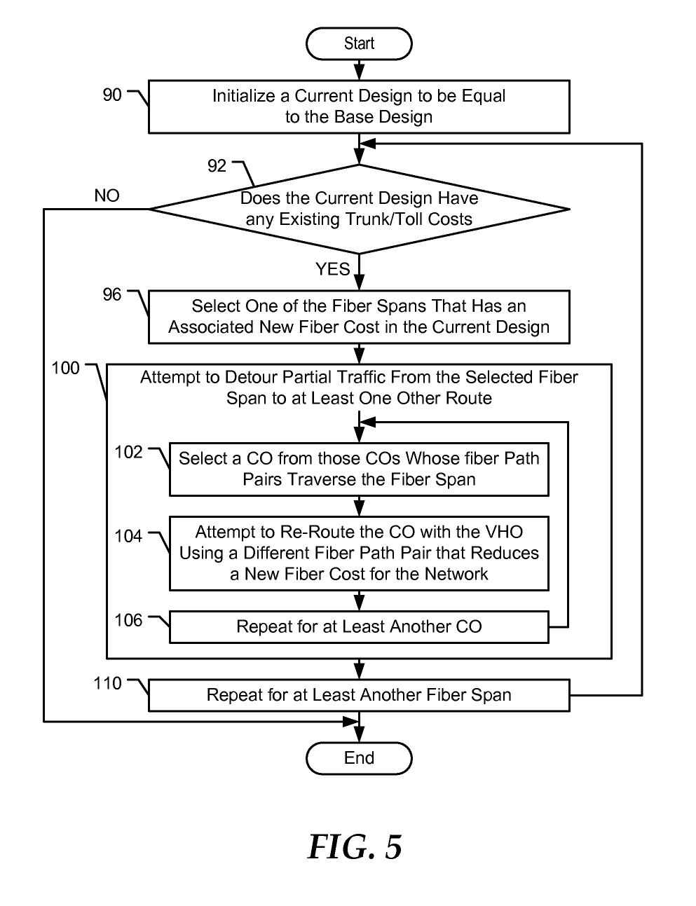

FIG. 5 is a flow chart of an embodiment of a method of modifying the base design to optimize an overall design cost of the design. In this embodiment, the base design of a network connects the COs to the VHO using a plurality of fiber path pairs, respectively, wherein each of the fiber path pairs is a new-fiber-cost-independent, lowest-cost, node-disjoint path pair between its respective one of the COs and the VHO. Further in this embodiment, the base design is modified to reduce a cost of adding new fiber to the network by re-routing traffic from at least one of the fiber path pairs to at least one other fiber path pair.

As indicated by block 90, the method comprises initializing a current design to be equal to the base design. As indicated by block 92, the method comprises determining if the current design has any existing trunk and toll cost. If the current design has no trunk and toll cost, then the design process is completed and the current design is final design of the network (block 94). Thus, if the base design does not require new fiber, then the final design is an unmodified version of base design.

If the current design has a trunk and toll cost, then an act of selecting one of the fiber spans that has an associated cost for adding new fiber in the current design is performed as indicated by block 96. In an embodiment, of all of the fiber spans that require trunk and toll, the fiber span having the smallest difference between a needed fiber number and a spare fiber number is selected in block 96. Optionally, the fiber spans that require trunk and toll can be sorted in increasing order of the difference between required capacity and spare capacity.

As indicated by block 100, the method comprises attempting to detour partial traffic from the selected fiber span to at least one other route. This act may comprise selecting a CO from those of the COs whose fiber path pairs traverse the fiber span (block 102), attempting to re-route the CO with the VHO using a different fiber path pair that reduces the cost of adding new fiber to the network (block 104), and repeating blocks 102 and 104 for at least another CO from those of the COs whose fiber path pairs traverse the fiber span (block 106).

In an embodiment, the repeated selections of the CO in block 102 is ordered by an increasing needed fiber value of those of the COs whose fiber path pairs traverse the fiber span. This may be effectuated by obtaining a list of COs whose path pairs traverse the selected fiber span, and returning the CO with a smallest needed fiber number.

In an embodiment, the act of attempting to re-route the selected CO comprises attempting to use different path pairs that do not traverse the selected fiber span to detour partial traffic, if possible. If such a path pair can lead to lower cost (e.g. can reduce a cost of adding new fiber), the path pair is used for re-routing for the selected CO. In a particular embodiment, an act of re-routing the CO comprises selecting the different path pair to be a shortest path pair between the CO and the VHO that does not traverse the fiber span, does not lead to a new cost of adding new fiber, and satisfies one or more feasibility conditions. Examples of feasibility conditions include, but are not limited to, satisfying a distance limit and satisfying a loss limit.

In an embodiment, block 106 comprises repeating blocks 102 and 104 until the selected fiber span does not require trunk and toll, e.g. the difference between the needed fiber value and the spare fiber value is less than or equal to zero. In an exemplary case, block 106 comprises repeating blocks 102 and 104 until the associated cost of adding new fiber to the fiber span is zero.

As indicated by block 110, the method comprises repeating block 96 and 100 for each other fiber span having an associated cost of adding new fiber in the design. The process may be repeated until all fiber spans that require new fiber are attempted to be re-routed. In an embodiment, the repeated selections of the fiber span is ordered by an increasing difference between a needed fiber value and a spare fiber value of fiber spans having an associated cost of adding new fiber in the design.

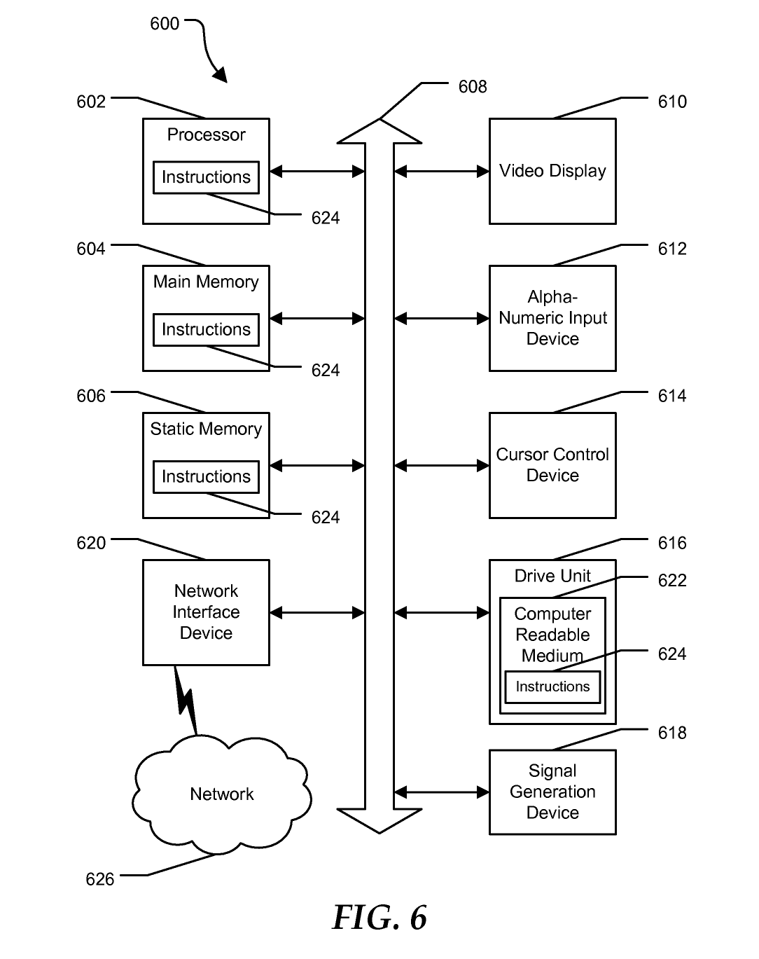

Referring to FIG. 6, an illustrative embodiment of a general computer system is shown and is designated 600. The computer system 600 can include a set of instructions that can be executed to cause the computer system 600 to perform any one or more of the methods or computer based functions disclosed herein. The computer system 600 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics processing unit (GPU), or both. Moreover, the computer system 600 can include a main memory 604 and a static memory 606 that can communicate with each other via a bus 608. As shown, the computer system 600 may further include a video display unit 610, such as a liquid crystal display (LCD), an organic light emitting diode (OLED), a flat panel display, a solid state display, or a cathode ray tube (CRT). Additionally, the computer system 600 may include an input device 612, such as a keyboard, and a cursor control device 614, such as a mouse. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

Wile the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
determining a design of a network to connect a plurality of central offices (COs) to a video hub office (VHO) using a plurality of fiber path pairs, respectively, wherein each of the fiber path pairs is a lowest-cost, node-disjoint path pair between its respective one of the COs and the VHO independent of a cost of adding new fiber to the network;
modifying the design to reduce the cost of adding new fiber to the network by re-routing traffic from at least one of the fiber path pairs to at least one other fiber path pair; and
outputting the modified design.

2. The method of claim 1 wherein said modifying the design comprises:
(a) selecting a fiber span that has an associated cost of adding new fiber in the design;
(b) selecting a CO from those of the COs whose fiber path pairs traverse the fiber span; and
(c) re-routing the CO with the VHO using a different fiber path pair that reduces the cost adding new fiber to the network.

3. The method of claim 2 wherein said modifying the design further comprises:
(d) repeating (b) and (c) for at least another CO from those of the COs whose fiber path pairs traverse the fiber span.

4. The method of claim 3 wherein (d) comprises repeating (b) and (c) until the associated cost of adding new fiber to the fiber span is zero.

5. The method of claim 3 wherein said selecting the CO is ordered by an increasing needed fiber value of those of the COs whose fiber path pairs traverse the fiber span.

6. The method of claim 2 wherein said modifying the design further comprises:
(e) repeating (a), (b), (c) and (d) for each other fiber span having an associated cost of adding new fiber in the design.

7. The method of claim 6 wherein said selecting the fiber span is ordered by an increasing difference between a needed fiber value and a spare fiber value of fiber spans having an associated cost of adding new fiber in the design.

8. The method of claim 2 wherein said re-routing the CO comprises selecting the different path pair to be a shortest path pair between the CO and the VHO that does not traverse the fiber span and does not lead to a new cost of adding new fiber.

9. The method of claim 1 further comprising:
deploying the modified design of the network.

10. A computer-readable medium encoded with a computer program, the computer program to cause a computer system to perform acts of:
determining a design of a network to connect a plurality of central offices (COs) to a video hub office (VHO) using a plurality of fiber path pairs, respectively, wherein each of the fiber path pairs is a lowest-cost, node-disjoint path pair between its respective one of the COs and the VHO independent of a cost of adding new fiber to the network;
modifying the design to reduce the cost of adding new fiber to the network by re-routing traffic from at least one of the fiber path pairs to at least one other fiber path pair; and
outputting the modified design.

11. The computer-readable medium of claim 10 wherein said modifying the design comprises:
(a) selecting a fiber span that has an associated cost of adding new fiber in the design;
(b) selecting a CO from those of the COs whose fiber path pairs traverse the fiber span; and
(c) re-routing the CO with the VHO using a different fiber path pair that reduces the cost adding new fiber to the network.

12. The computer-readable medium of claim 11 wherein said modifying the design further comprises:
(d) repeating (b) and (c) for at least another CO from those of the COs whose fiber path pairs traverse the fiber span.

13. The computer-readable medium of claim 12 wherein (d) comprises repeating (b) and (c) until the associated cost of adding new fiber to the fiber span is zero.

14. The computer-readable medium of claim 12 wherein said selecting the CO is ordered by an increasing needed fiber value of those of the COs whose fiber path pairs traverse the fiber span.

15. The computer-readable medium of claim 11 wherein said modifying the design further comprises:
(e) repeating (a), (b), (c) and (d) for each other fiber span having an associated cost of adding new fiber in the design.

16. The computer-readable medium of claim 15 wherein said selecting the fiber span is ordered by an increasing difference between a needed fiber value and a spare fiber value of fiber spans having an associated cost of adding new fiber in the design.

17. The computer-readable medium of claim 11 wherein said re-routing the CO comprises selecting the different path pair to be a shortest path pair between the CO and the VHO that does not traverse the fiber span and does not lead to a new cost of adding new fiber.

18. A computer system programmed to perform acts of:
determining a design of a network to connect a plurality of central offices (COs) to a video hub office (VHO) using a plurality of fiber path pairs, respectively, wherein each of the fiber path pairs is a lowest-cost, node-disjoint path pair between its respective one of the COs and the VHO independent of a cost of adding new fiber to the network;
modifying the design to reduce the cost of adding new fiber to the network by re-routing traffic from at least one of the fiber path pairs to at least one other fiber path pair; and
outputting the modified design.

19. The computer system of claim 18 wherein said modifying the design comprises:
(a) selecting a fiber span that has an associated cost of adding new fiber in the design;
(b) selecting a CO from those of the COs whose fiber path pairs traverse the fiber span; and
(c) re-routing the CO with the VHO using a different fiber path pair that reduces the cost adding new fiber to the network.

20. A system comprising:
a video hub office (VHO);
a plurality of central offices (COs); and
a network to connect the plurality of COs to the VHO, the network being designed by:
determining a design of a network to connect a plurality of central offices (COs) to a video hub office (VHO) using a plurality of fiber path pairs, respectively, wherein each of the fiber path pairs is a lowest-cost, node-disjoint path pair between its respective one of the COs and the VHO independent of a cost of adding new fiber to the network;
modifying the design to reduce the cost of adding new fiber to the network by re-routing traffic from at least one of the fiber path pairs to at least one other fiber path pair.

21. The system of claim 20 wherein said modifying the design comprises:
(a) selecting a fiber span that has an associated cost of adding new fiber in the design;
(b) selecting a CO from those of the COs whose fiber path pairs traverse the fiber span; and
(c) re-routing the CO with the VHO using a different fiber path pair that reduces the cost adding new fiber to the network.
